(19) United States
(12) Patent Application Publication
(10) Pub. No.: US 2021/0114018 A1
(43) Pub. Date: Apr. 22, 2021

(54) REACTION VESSEL AND FLUORESCENCE MEASURING APPARATUS USING THE REACTION VESSEL

(71) Applicant: SHIMADZU CORPORATION, Kyoto-shi (JP)

(72) Inventors: Naoko TAKAOKA, Kyoto-shi (JP); Masamitsu SHIKATA, Kyoto-shi (JP); Kenji NINOMIYA, Kyoto-shi (JP); Shinichiro KOBAYASHI, Kyoto-shi (JP)

(73) Assignee: SHIMADZU CORPORATION, Kyoto-shi (JP)

(21) Appl. No.: 16/657,336

(22) Filed: Oct. 18, 2019

(51) Int. Cl. B01L 3/00; G01N 21/03; G01N 21/64

(52) U.S. Cl. CPC B01L 3/5085; G01N 21/0303; B01L 2300/0829; B01L 2300/168; B01L 2300/0851; G01N 21/64

(57) ABSTRACT

A reaction vessel has plural wells each configured to accommodate a sample on the same plane or on the same straight line. Among the wells of a well plate, a specific well other than a well at a center of point symmetry is an orientation recognizing well in which a fluorescent dye is placed. The reaction vessel can identify a position of the orientation recognizing well by using fluorescence emitted from the fluorescent dye, and can thereby recognize an orientation of the reaction vessel.

### TECHNICAL FIELD

The present invention relates to a reaction vessel having plural wells for accommodating a sample containing genes, and a fluorescence measuring apparatus that measures fluorescence from the sample contained in each well of the reaction vessel.

### BACKGROUND ART

In the field of genetic testing, a reaction vessel such as a well plate having plural wells or a connecting tube is often used (see, for example, Patent Document 1). A sample is accommodated in a well of the reaction vessel together with a reagent such as a polymerase chain reaction (PCR) reagent, and the reaction vessel is set in a measuring apparatus such as a real-time PCR apparatus. The real-time PCR apparatus can measure fluorescence intensity from a gene in a sample labeled with a fluorescent dye in parallel with a gene amplification process that amplifies a specific gene in the sample, and can perform various analysis processes using the measurement results. An apparatus that measures the fluorescence intensity from the gene in the sample labeled with the fluorescent dye in this way is generically called a fluorescence measuring apparatus.

A 96-well plate, which is one of the commercially available reaction vessels, has 96 wells arranged in matrix of 8 rows in the vertical direction and 12 columns in the horizontal direction. In the fluorescence measuring apparatus that handles the above wells, a position of each well of the well plate is identified by an identification code (for example, A10 (10th well from the left end of the A row), C7 (7th well from the left end of the C row), and the like), constituted by a combination of a code representing a position of the row in the vertical direction (for example, A to H) and a code representing a position of the column in the horizontal direction (for example, 1 to 12).

Before starting measurement with the fluorescence measuring apparatus, a user can register, in the apparatus, information about the sample such as a sample ID of the sample contained in each well of the reaction vessel and analysis items to be performed. The information about the sample input by the user is registered in association with the identification code of the well in which the sample is accommodated. With this configuration, the analysis result about the sample accommodated in each well can be obtained in a state associated with the sample ID accommodated in each well.

### PRIOR ART DOCUMENT

### Patent Document

Patent Document 1: Japanese Patent Publication No. 2007-526767 A

### SUMMARY OF THE INVENTION

### Problems to be Solved by the Invention

Because the reaction vessels such as the well plates have symmetrical shapes in vertical and horizontal directions respectively, it is difficult for the user to determine an orientation of the reaction vessel. For this reason, there is one in which a frame having a width of about 10 mm is provided on an outer periphery of the reaction vessel and on which the identification codes representing the positions of the wells (for example, A to H in the vertical direction, 1 to 12 in the horizontal direction, and the like) are printed. In addition, there is one in which a notch indicating the orientation of the reaction vessel is provided at one corner of the outer peripheral frame, (for example, near the upper right A12 well).

However, the identification codes printed on the frame of the reaction vessel are formed simultaneously with resin molding of the reaction vessel and has the same color as the reaction vessel, causing visibility of the codes to be poor. Moreover, because the position of the notch provided in the frame differs depending on the manufacturer, there is a possibility that the user misidentifies the orientation of the reaction vessel. As a result, there has been a case of the user mistaking, without being aware, the setting orientation of the reaction vessel in the fluorescence measuring apparatus.

When the user sets the reaction vessel in the fluorescence measuring apparatus in a wrong orientation, the position where the well having each sample stored therein is arranged does not match with the position information of the sample registered in the apparatus. Accordingly, there is a problem that the analysis process different from the analysis process designated by the user is performed for each sample, or the analysis result for each sample is mistaken for another sample.

Therefore, an object of the present invention is to make it easy to correctly recognize the result even when the setting orientation of the reaction vessel with respect to the fluorescence measuring apparatus is wrong.

### Solutions to the Problems

The reaction vessel according to the present invention is a well plate or connecting tube having plural wells for accommodating a sample on the same plane or the same straight line, and has a fluorescent dye accommodated in a specific well other than a well provided at a center of point symmetry among the plural wells. The well in which the fluorescent dye is accommodated is referred to as an orientation recognizing well. That is, in the reaction vessel of the present invention, the position of a specific well or the orientation of the reaction vessel is determined using fluorescence emitted from the fluorescent dye.

As the fluorescent dye, a fluorescent dye having a fluorescence wavelength suitable for the purpose can be selected and used from fluorescent dyes such as fluorescein, fluorescein amidite, rhodamine, and the like. Normally, a fluorescent dye with a fluorescence wavelength different from that of a fluorescent dye for detection of amplified DNA contained in the reaction reagent is selected. If the fluorescent dye can be distinguished by an increase in the fluorescence level baseline, a fluorescent dye with the same fluorescence wavelength may be selected.

Examples of the reaction reagent include a real-time PCR (RT-PCR) reaction reagent for measuring the expression level of a gene and a reagent for the single nucleotide polymorphisms (SNP) analysis for determining a genotype. As the fluorescent dye that develops color when the reaction reagent is added, in addition to SYBR (registered trademark, product of Thermo Fisher Scientific) Green I, fluorescent dyes that emit fluorescence when coupled to nucleic acids, and fluorescent dyes labeled with probes that detect nucleic acids can be used.

The fluorescent dye may be accommodated in the orientation recognizing well in a solid phase state so that the fluorescent dye dissolves when the reaction reagent is added to the orientation recognizing well.

When the reaction vessel of the present invention is the one having the plural wells arranged in a matrix within the plane, the well provided at the corner of the plane or in the vicinity thereof is preferably the orientation recognizing well. With this configuration, a positional relationship of the orientation recognizing well in the plane of the well plate can be easily distinguished, and the operativity of the user who adds the reaction reagent improves.

The fluorescence measuring apparatus according to the present invention includes: a reaction vessel setting part on which the reaction vessel of the present invention described above is set; and a measurement part configured to measure an intensity of light having a measurement target wavelength from inside of each of the wells of the reaction vessel set on the reaction vessel setting part, and having a function of detecting fluorescence emitted from a fluorescent dye placed in the orientation recognizing well of the reaction vessel.

The fluorescence measuring apparatus according to the present invention may further include a measurement value correction part configured to correct a measurement value for the orientation recognizing well based on a difference between a baseline of the measurement value for the orientation recognizing well of the reaction vessel measured by the measurement part and baselines of measurement values for the other wells measured by the measurement part when a wavelength of the fluorescence emitted from the fluorescent dye of the orientation recognizing well of the reaction vessel is the same as the measurement target wavelength. According to this configuration, even if the fluorescent dye accommodated in the orientation recognizing well of the reaction vessel emits fluorescence having the same wavelength as the measurement target wavelength, the influence of the fluorescence emitted from the fluorescent dye on the measurement is eliminated.

As described above, the reaction vessel of the present invention includes the orientation recognizing well at the specific position, and the fluorescent dye is accommodated in the orientation recognizing well. When the fluorescence intensity from each well of the reaction vessel is measured by the measurement part, the fluorescence or fluorescence intensity baseline from the fluorescent dye that exists only in the orientation recognizing well where the fluorescent dye is accommodated in advance becomes higher than that of the other wells. Therefore, in the fluorescence measuring apparatus of the present invention, the difference between the fluorescence or measurement value baseline for the orientation recognizing well and the measurement value baselines for the other wells can be measured.

Additionally, the fluorescence measuring apparatus according to the present invention can be adapted to the case where the wavelength of fluorescence emitted from the fluorescent dye in the orientation recognizing well of the reaction vessel is different from the measurement target wavelength.

In this way, by measuring the fluorescence from the fluorescent dye placed in the orientation recognizing well, and when the fluorescent dye accommodated in the orientation recognizing well has the same wavelength as that used for the measurement of the sample, the position of the orientation recognizing well of the reaction vessel installed in the reaction vessel setting part can be identified by comparing the measurement value baseline of the orientation recognizing well with the measurement value baselines of the other wells.

Therefore, the fluorescence measuring apparatus of the present invention preferably includes a well position identification part configured to identify the position of the orientation recognizing well based on the measurement value of each well obtained by the measurement part. If the position of the orientation recognizing well can be identified, the information can be used to automatically distinguish the setting orientation of the reaction vessel.

In addition, because the position of the orientation recognizing well in the reaction vessel is predetermined, by storing the position in the apparatus as an original position of the orientation recognizing well (original position), the function of the well position identification part described above can be used to confirm whether or not the reaction vessel is installed in the correct orientation in the reaction vessel setting part.

Therefore, the fluorescence measuring apparatus of the present invention may further include a well position determination part configured to determine whether or not the original position of the orientation recognizing well specified in advance matches with an actual position of the orientation recognizing well identified by the well position identification part.

The well position determination part may be configured to issue a warning to the user when the actual position identified by the well position identification part does not match with the original position. With this configuration, the user can easily recognize an error in the setting orientation of the reaction vessel.

Additionally, information (sample information) related to the sample accommodated in each well of the reaction vessel is registered in the apparatus in association with the position of the well in which each sample is accommodated. In the present application, the above part that stores the sample information is referred to as a sample information storage part. If the reaction vessel is set in the wrong orientation, the arrangement of each sample on the reaction vessel setting part registered in advance in the apparatus becomes different from the arrangement of each sample actually installed on the reaction vessel setting part.

On the other hand, by using the function of the above well position identification part, the apparatus can recognize how the reaction vessel is set in the reaction vessel setting part. Therefore, the fluorescence measuring apparatus of the present invention may include a correspondence relation correction part configured to, when the well position determination part determines that the actual position identified by the well position identification part does not match with the original position, correct a correspondence relation of the position of the well to the sample information of the sample information storage part based on the actual position of the orientation recognizing well identified by the well position identification part, so that the sample information stored in the sample information storage part is associated with the position of the well in which each sample is actually accommodated. With this configuration, even if the user sets the reaction vessel in the wrong orientation in the reaction vessel setting part, the apparatus automatically recognizes the mistake and corrects the correspondence relation between the sample information registered in advance and the position of the well. Accordingly, the situation of mistaking the analysis result for the sample does not occur.

### Effects of the Invention

In the reaction vessel according to the present invention, the well provided at the specific position other than the well provided at the center of point symmetry among all the wells is the orientation recognizing well in which the fluorescent dye is accommodated, therefore, the orientation of the reaction vessel can be easily distinguished using the fluorescence emitted from the fluorescent dye. The reaction vessel can be used not only for PCR measurement using the PCR measuring apparatus, but also for measurement of a melting curve of the sample after PCR processing is performed by the PCR measuring apparatus. Furthermore, the reaction vessel can be applied not only to PCR but also to antigen-antibody reaction and enzyme reaction using fluorescence detection.

In the fluorescence measuring apparatus according to the present invention, the measurement part for measuring the light of the measurement target wavelength from each well of the reaction vessel has the function of detecting the fluorescence from the fluorescent dye accommodated in the orientation recognizing well, accordingly, the position of the orientation recognizing well of the reaction vessel can be identified.

### BRIEF DESCRIPTION OF THE DRAWINGS

FIG. 1 is a perspective view showing one embodiment of a well plate.

FIG. 2 is a plan view of the same embodiment.

FIG. 3 is a schematic cross-sectional configuration view showing one embodiment of a fluorescence measuring apparatus.

FIG. 4 is a diagram showing an example of detection signal waveforms of a normal well and a orientation recognizing well according to the same embodiment.

FIG. 5 is a flowchart showing an example of operation of the same embodiment.

FIG. 6 is a plan view of a well plate showing an arrangement of each well when the well plate is placed in a wrong orientation.

FIG. 7 is a flowchart showing another example of the operation of the same embodiment.

### EMBODIMENT OF THE INVENTION

Hereinafter, one embodiment of a reaction vessel and a fluorescence measuring apparatus is described using drawings.

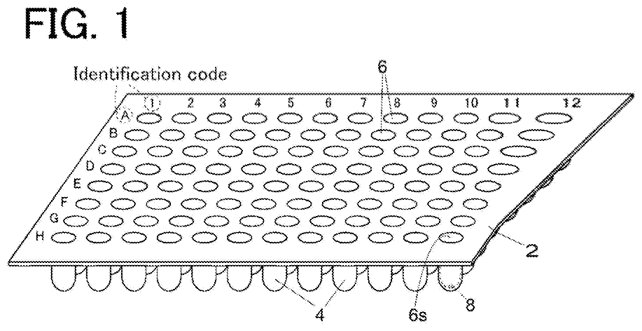

First, one embodiment of the reaction vessel is described with reference to FIG. 1.

A reaction vessel 2 of this embodiment formed by plural vessels 4 which are arranged in the same plane and are integrated with each other. Each vessel 4 includes a well 6 that is open at a top. The well 6 is for accommodating a sample and a reaction reagent therein. In this embodiment, the wells 6 are arranged in a matrix of 8 rows in the vertical direction and 12 columns in the horizontal direction. In order to identify a position of each well 6, a left end and a top end of an upper surface of a well plate 2 are respectively labeled with identification codes A to H indicating rows in the vertical direction and identification codes 1 to 12 indicating columns in the horizontal direction.

Among the wells 6 provided in the reaction vessel 2, a fluorescent dye 8 is accommodated in the well 6 provided at a specific position other than a center of point symmetry. In this embodiment, the fluorescent dye 8 is accommodated in the well 6 at H12 (12th from the left in the row H) located at a lower right end of the reaction vessel 2. Hereinafter, the well 6 in which the fluorescent dye 8 is accommodated is referred to as a orientation recognizing well 6s so as to be distinguished from the other wells 6. Note that the position of the orientation recognizing well 6s where the fluorescent dye 8 is accommodated may be the position of the well other than the center of point symmetry in all the wells 6.

The fluorescent dye 8 placed in the orientation recognizing well 6s is solidified by drying, for example. The fluorescent dye 8 preferably has a property of being dissolved and colored when the reaction reagent is added to the orientation recognizing well 6s. However, the fluorescent dye is not necessarily required to be colored by the addition of the reaction reagent, and one that emits fluorescence when irradiated with excitation light may be used. The fluorescent dye 8 is not necessarily be solid-phased, and may be sealed in the orientation recognizing well 6s by any means. As the fluorescent dye, SYBR (registered trademark) Green I, SYBR (registered trademark) Gold, EvaGreen (registered trademark), and the like can be used.

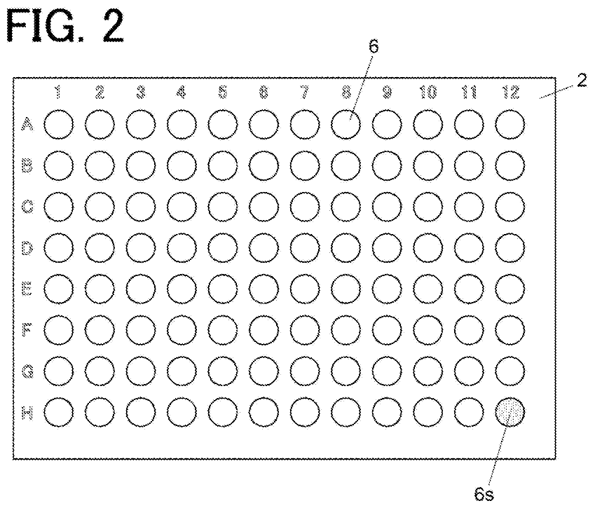

Because the fluorescent dye having the property of being colored when the reaction reagent is added, is fixed in the orientation recognizing well 6s, when the reaction reagent is added to the orientation recognizing well 6s, the orientation recognizing well 6s provided at the specific position is colored as shown in FIG. 2. Accordingly, an orientation of the reaction vessel 2 can be visually confirmed. When the fluorescent dye that emits fluorescence without adding the reaction reagent but by irradiation with the excitation light is used as the fluorescent dye 8, the reaction reagent is not necessarily added to the orientation recognizing well 6s, but instead, the position of the orientation recognizing well 6s can be distinguished by measuring a fluorescence intensity obtained by irradiating each well 6 with the excitation light.

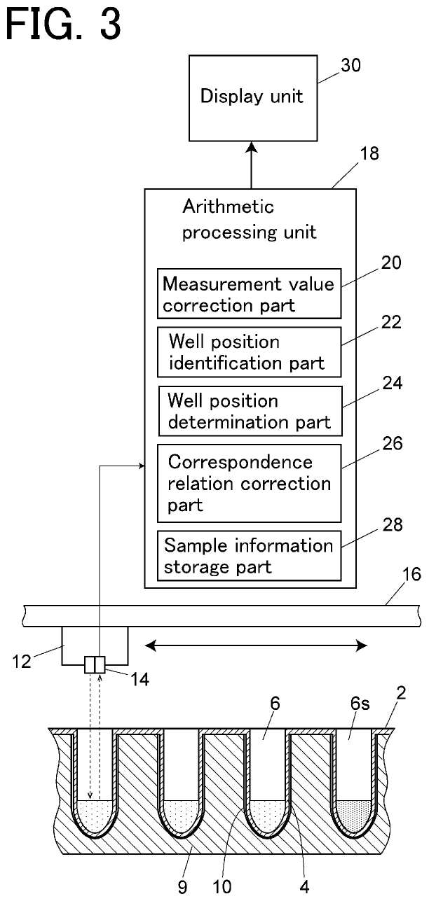

Next, an embodiment of a fluorescence measuring apparatus using the reaction vessel 2 is described with reference to FIG. 3.

The fluorescence measuring apparatus includes a reaction vessel setting part 9 for setting the reaction vessel 2. The reaction vessel setting part 9 is made of heat conductive metal material, and has temperature thereof adjusted by, for example, a Peltier element or a heater. The reaction vessel setting part 9 is provided with recesses 10 each of which accommodates each vessel 4 of the reaction vessel 2.

A measurement part 12 is provided above the reaction vessel setting part 9. The measurement part 12 includes an optical sensor 14. The optical sensor 14 includes a light emitting element that emits excitation light vertically downward and a light receiving element for detecting fluorescence from the sample excited by the excitation light.

The measurement part 12 is configured to bring the optical sensor 14 at a position immediately above each well 6 so that each well 6 in the reaction vessel 2 is scanned in order during the measurement, and to measure an intensity of light of a measurement target wavelength from the sample accommodated in each well 6. In addition, the measurement part 12 has a function of detecting by the optical sensor 14, fluorescence from the fluorescent dye placed in the orientation recognizing well 6s of the reaction vessel 2. A detection signal obtained by the optical sensor 14 is taken into an arithmetic processing unit 18. The arithmetic processing unit 18 is realized by a dedicated computer or a general-purpose personal computer. A display unit 30 is connected to the arithmetic processing unit 18. The display unit 30 can be realized by a liquid crystal display, for example.

The arithmetic processing unit 18 has a function of performing various analysis processes based on the detection signal from the optical sensor 14. The analysis process performed by the arithmetic processing unit 18 includes, for example, absolute quantitative analysis for obtaining a concentration of a measurement sample, relative quantitative analysis for obtaining a relative expression level with respect to a gene, and SNP analysis for determining a genotype. A user can set a desired analysis process to be performed on the sample to be measured as a measurement condition.

Alternatively, the measurement part 12 may be provided so as to be moved in a horizontal plane below the reaction vessel setting part 9. In that case, in order to enable the measurement of the light of the measurement target wavelength from the sample accommodated in each well 6 by the optical sensor 14 of the measurement part 12, an opening for measurement is provided at a bottom part of the recess of the reaction vessel setting part 9.

The arithmetic processing unit 18 includes a measurement value correction part 20, a well position identification part 22, a well position determination part 24, a correspondence relation correction part 26, and a sample information storage part 28. The measurement value correction part 20, the well position identification part 22, the well position determination part 24, and the correspondence relation correction part 26 are functions obtained by an arithmetic element such as a CPU provided in the arithmetic processing unit 18 executing a predetermined program. The sample information storage part 28 is a function realized by a partial area of a storage unit provided in the arithmetic processing unit 18.

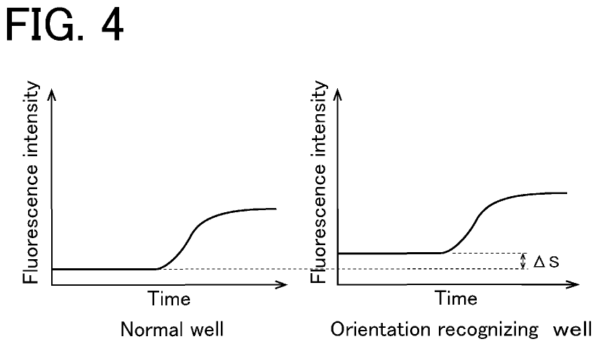

The measurement value correction part 20 is configured to correct a measurement value of the intensity of the light of the measurement target wavelength of the sample accommodated in the orientation recognizing well 6s of the well plate 2, when the wavelength of the fluorescence emitted from the fluorescent dye placed in the orientation recognizing well 6s of the reaction vessel 2 is the same as the measurement target wavelength. When the wavelength of the fluorescence emitted from the fluorescent dye accommodated in the orientation recognizing well 6s of the reaction vessel 2 is the same as the measurement target wavelength, and when the fluorescence intensity from each well 6 of the reaction vessel 2 is measured by the optical sensor 14, a fluorescence intensity baseline of the orientation recognizing well 6s in which the fluorescent dye is accommodated in advance becomes higher than that of the normal well 6 as shown in FIG. 4. The measurement value correction part 20 obtains a difference ΔS between the fluorescence intensity baseline of the normal well 6 and the fluorescence intensity baseline of the orientation recognizing well 6s, and subtracts the difference ΔS from the measurement value of the sample in the orientation recognizing well 6s, thereby correcting the measurement value of the sample in the orientation recognizing well 6s. Accordingly, the fluorescence intensity of the sample can be measured using the orientation recognizing well 6s in the same manner as the normal well 6. As the baseline of the normal well 6, for example, an average value of the baselines of all the wells 6 other than the orientation recognizing well 6s among the wells 6 provided in the reaction vessel 2 can be used.

The well position identification part 22 is configured to identify an actual position of the orientation recognizing well 6s on the reaction vessel setting part 9 by comparing the measurement values of the fluorescence intensity for respective wells 6 of the reaction vessel 2. When the wavelength of the fluorescence emitted from the fluorescent dye accommodated in the orientation recognizing well 6s of the reaction vessel 2 is the same as the measurement target wavelength, for the orientation recognizing well 6s in which the fluorescent dye is accommodated in advance, the measurement value of the intensity of the light having the measurement target wavelength is larger than the measurement value of the intensity of the light having the measurement target wavelength for the other wells 6. For this reason, by comparing the fluorescence intensities measured by the optical sensor 14 for respective wells 6, it is possible to specify which position the orientation recognizing well 6s is arranged on the reaction vessel setting part 9. In addition, when the wavelength of the fluorescence emitted from the fluorescent dye placed in the orientation recognizing well 6s of the reaction vessel 2 is different from the measurement target wavelength, the position of the orientation recognizing well 6s can be identified by searching the well 6 in which the light having the wavelength emitted from the fluorescent dye is detected.

The well position determination part 24 is configured to determine whether or not the position of the orientation recognizing well 6s identified by the well position identification part 22 is correctly arranged at a specified position. In the arithmetic processing unit 18, a specific position where the orientation recognizing well 6s is provided in the reaction vessel 2, that is, for example, the position H12 is registered in advance as the specified position. This specified position is a position where the orientation recognizing well 6s should be arranged when the reaction vessel 2 is set in the reaction vessel setting part 9 in the correct orientation. The well position determination part 24 is configured to determine whether or not the actual position of the orientation recognizing well 6s identified by the well position identification part 22 matches with the specified position.

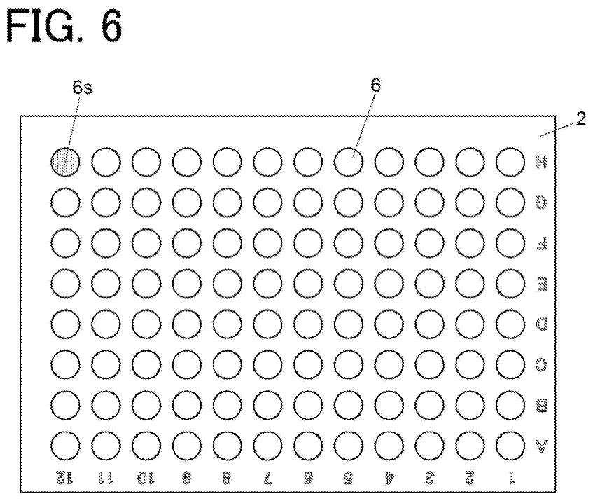

When the reaction vessel 2 is set in the correct orientation in the reaction vessel setting part 9, the actual position of the orientation recognizing well 6s identified by the well position identification part 22 matches with the specified position. However, as shown in FIG. 6, when the orientation of the reaction vessel 2 is wrong, the orientation recognizing well 6s is arranged in a position (position A1 in FIG. 6) different from the specified position (position H12). Therefore, the actual position of the orientation recognizing well 6s identified by the well position identification part 22 does not match with the specified position. With this configuration, it is possible to automatically determine whether or not a setting orientation of the reaction vessel 2 is correct on an apparatus side.

The correspondence relation correction part 26 is configured to correct a correspondence relation between the sample information regarding each sample accommodated in each well 6 of the reaction vessel 2 and the position of the well 6 in which each sample is accommodated.

Before the measurement is started, the user registers, for example, a sample ID of the sample stored in each well 6 and a measurement condition for each sample as sample information. The sample information of each sample is registered in association with the position of the well 6 used for measuring each sample. The sample information registered in the apparatus by the user is stored in the sample information storage part 28.

However, as shown in FIG. 6, when the user sets the reaction vessel 2 in the wrong orientation in the reaction vessel setting part 9, the actual position on the reaction vessel setting part 9 for the well 6 in which each sample is accommodated becomes different from the information stored in the sample information storage part 28. By referring to FIG. 6, the well 6 provided at the position A1 of the reaction vessel 2 is arranged at the position H12 on the reaction vessel setting part 9, and the well 6 provided at the position A2 of the reaction vessel 2 is arranged at the position H11 on the reaction vessel setting part 9.

In response to this, the correspondence relation correction part 26 determines in which orientation the reaction vessel 2 is set on the reaction vessel setting part 9 based on the position of the orientation recognizing well 6s, identified by the well position identification part 22, on the reaction vessel setting part 9, and corrects the sample information of each sample stored in the sample information storage part 28 so as to associate the sample information with the actual position on the reaction vessel setting part 9 for the well 6 in which each sample is accommodated.

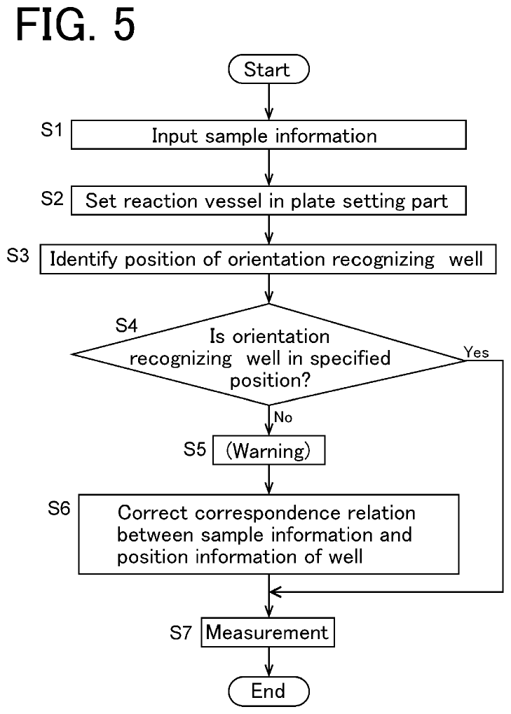

An example of operation of this embodiment is described with reference to FIG. 5.

First, the user inputs the sample information, and the sample information of each sample is stored in the sample information storage part 28 in association with the position of the well 6 in which each sample is accommodated (step S1). Thereafter, the user sets the reaction vessel 2 on the reaction vessel setting part 9 (step S2). This completes preparation of measurement. When the user adds the reagent to each well 6 of the well plate 2 before setting the reaction vessel 2 in the reaction vessel setting part 9, only the orientation recognizing well 6 is colored, accordingly, the user can easily recognize the orientation of the well plate 2.

When the preparation of measurement is completed, the user performs some operation to indicate the completion. Examples of the operation indicating the completion of the preparation of measurement include operation to input the completion to the arithmetic processing unit 18, and operation to close a cover (not shown) covering an upper part of the reaction vessel setting part 9, and the like. When the user performs the above operation, the well position identification part 20 recognizes that the preparation of measurement is completed, and scans all the wells 6 in the reaction vessel 2 using the optical sensor 14 of the measurement part 12, thereby identifying the position of the orientation recognizing well 6s (step S3).

After the position of the orientation recognizing well 6s is identified, the well position determination part 24 determines whether or not the position of the orientation recognizing well 6s is in the specified position (step S4), and if the position is in the specified position, the measurement is started (step S7). In the measurement, the measurement value of the sample in the orientation recognizing well 6s is corrected by the measurement value correction part 20.

If the position of the orientation recognizing well 6s is not at the specified position, the well position determination part 24 issues a warning to the user (step S5). Examples of the warning include displaying the indication on the display unit 30 connected to the arithmetic processing unit 18, generating a warning sound, and the like. It is not always necessary to give the warning to the user.

When the position of the orientation recognizing well 6s is not at the specified position, the correspondence relation correction part 26 corrects the sample information of each sample stored in the sample information storage part 28 so that the sample information is associated with the actual position on the reaction vessel setting part 9 for the well 6 in which each sample is accommodated (step S6). Thereafter, the measurement is started (step S7).

Not limited to the above, the correspondence relation correction part 26 may correct the correspondence relation between measurement data and the sample information so that the measurement data obtained by the measurement is correctly associated with the sample after the measurement is completed.

The correspondence relation correction part 26 is not an essential component. Therefore, even when the setting orientation of the reaction vessel 2 is wrong, the correspondence relationship between the sample information and the well position information may not be automatically corrected.

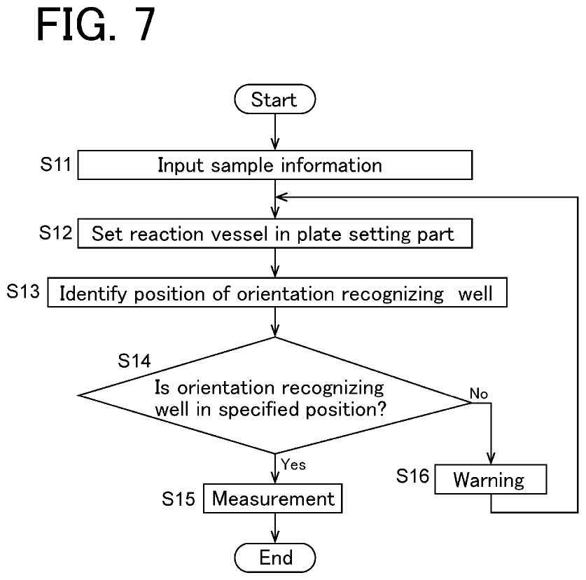

An example of operation of a fluorescence detection apparatus that does not include the correspondence relation correction part 26 is described with reference to FIG. 7.

Further, in the example of FIG. 7, after the user inputs sample information (step S11) and sets the reaction vessel 2 in the reaction vessel setting part 9 (step S12), the well position identification part 20 identifies the position of the orientation recognizing well 6s (step S13). After the position of the orientation recognizing well 6s is identified, the well position determination part 24 determines whether or not the position of the orientation recognizing well 6s is in a specified position (step S14), and if the orientation recognizing well 6s is in the specified position, the measurement is started (step S15).

On the other hand, if the position of the orientation recognizing well 6s is not at the specified position, the well position determination part 24 issues a warning to the user and waits without starting the measurement (step S16). The user recognizes that the setting orientation of the reaction vessel 2 is wrong by the warning, and sets the well plate 2 again (step S12). Thereafter, the well position identification part 20 identifies the position of the orientation recognizing well 6s (step S13), and the well position determination part 24 determines whether or not the position of the orientation recognizing well 6s is at the specified position (step S14), and further, if the orientation recognizing well 6s is at the specified position, the measurement is started (step S15).

### DESCRIPTION OF REFERENCE SIGNS

2: Reaction vessel
4: Vessel
6: Well
6s: Orientation recognizing well
8: Fluorescent dye
9: Reaction vessel setting part
10: Recess
12: Measurement part
14: Optical sensor
16: Guide rail
18: Arithmetic processing unit
20: Measurement value correction part
22: Well position identification part
24: Well position determination part
26: Correspondence relation correction part
28: Sample information storage part
30: Display unit

1. A reaction vessel in which a plurality of wells for accommodating a sample are provided on a same plane or on a same straight line,
wherein, the reaction vessel comprises an orientation recognizing well which is a well other than a well provided at a center of point symmetry among the plurality of wells, a fluorescent dye is accommodated in the orientation recognizing well.

2. The reaction vessel according to claim 1,
wherein the plurality of wells are arranged in matrix in the plane, and
wherein the orientation recognizing well is a well provided at a corner or near the corner of the plane.

3. A fluorescence measuring apparatus, comprising:
a reaction vessel setting part on which the reaction vessel according to claim 1 is set; and
a measurement part configured to measure an intensity of light of a measurement target wavelength from inside of each of the wells of the reaction vessel set on the reaction vessel setting part, and to detect fluorescence emitted from the fluorescent dye in the orientation recognizing well of the reaction vessel.

4. The fluorescence measuring apparatus according to claim 3, comprising a measurement value correction part configured to correct a measurement value for the orientation recognizing well based on a difference between a baseline of the measurement value for the orientation recognizing well of the reaction vessel measured by the measurement part and baselines of measurement values for the other wells measured by the measurement part when a wavelength of the fluorescence emitted from the fluorescent dye of the orientation recognizing well of the reaction vessel is the same as the measurement target wavelength.

5. The fluorescence measuring apparatus according to claim 3, wherein the wavelength of the fluorescence emitted from the fluorescent dye in the orientation recognizing well of the reaction vessel is different from the measurement target wavelength.

6. The fluorescence measuring apparatus according to claim 3, further comprising a well position identification part configured to identify a position of the orientation recognizing well based on measurement values of each of the wells obtained by the measurement part.

7. The fluorescence measuring apparatus according to claim 6, further comprising a well position determination part configured to determine whether or not an actual position of the orientation recognizing well identified by the well position identification part matches with an original position set in advance for the orientation recognizing well.

8. The fluorescence measuring apparatus according to claim 7, wherein the well position determination part is configured to issue a warning to a user when the actual position identified by the well position identification part does not match with the original position.

9. The fluorescence measuring apparatus according to claim 7, further comprising:
a sample information storage part configured to store sample information, which is information related to the sample accommodated in each of the wells of the reaction vessel set in the reaction vessel setting part, in association with the position of the well in which each sample is accommodated; and
a correspondence relation correction part configured to, when the well position determination part determines that the actual position identified by the well position identification part does not match with the original position, correct a correspondence relation of the position of the well to the sample information of the sample information storage part based on the actual position of the orientation recognizing well identified by the well position identification part, so that the sample information stored in the sample information storage part is associated with the position of the well in which each sample is actually accommodated.
